(19) United States
(12) Patent Application Publication
(10) Pub. No.: US 2008/0247915 A1
(43) Pub. Date: Oct. 9, 2008

(54) Apparatus for the preparation of mammalian specimens for cryopreservation and/or vitrification, and for thawing and using susch specimens

(75) Inventors: Michael D. Cecchi, Madison, CT (US); Jacques Cohen, New York, NY (US); Tim Shimmel, Randolph, NJ (US)

Correspondence Address: William W. Jones, 6 Juniper Lane, Madison, CT, 06443, US

(73) Assignee: Genx International, Inc.

(21) Appl. No.: 11/732,744

(22) Filed: Apr. 5, 2007

(51) Int. Cl. B01L 3/00

(52) U.S. Cl. 422/102; 435/283.1

(57) ABSTRACT

A biological specimen processing dish assembly includes a dish portion for use in treating specimens such as oocytes, embryos, tissues, and the like sequientially with different reagents or media. The dish includes a plurality of geometrically arranged wells disposed in related sets. The wells are operative to receive reagents or media for the use in treatment of the specimens in question. The specimens can be subjected to a sequence of different treatment media in the wells in a set thereof so as to provide a coherant device for subjecting specimens to a treatment procedure that requires the specimens to be subjected to different media or reagents during sequencial steps in the treatment protocol. The dish can be partially filled with a layer of oil that overlies the reagents in the wells and protects the specimens from exposure to air during the treatment protocol. The dish can be provided with an internal partition that segments the dish so as to provide a plurality of wells that will not be covered by the oil layer. The assembly can also include a cover for overlying the dish so as to provide areas where protocol information can be displayed to enable the technician to properly use the dish assembly in performance of the treatment protocols.

### TECHNICAL FIELD

This invention relates to an apparatus for the preparation of mammalian cells and tissue specimens for cryopreservation and vitrification. The apparatus is particularly useful for the maintaining of multiple medium solutions and to regulate the timing of the process, which will make the process more consistent and more productive.

### BACKGROUND ART

Biological organisms are commonly preserved by freezing and or vitrification of types of specimens, such as stem cells, tissues including, but not limited to, immature oocytes, oocytes, gametes, zygotes, embryos, cleavage stage embryos, blastocyst stage embryos, and the like. Petri dishes are generally designed for use by the individual technician for use in a broad range of procedures and applications. Currently there is no Petri dish-style or similar device however that is specifically designed for use during the preparation of the specimens for freezing and/or for thawing the specimens. More specifically, there is no dish or other device that is designed to be used for the preparation of human and animal specimens in the cryopreservation and thawing process.

Currently, there are two methods used for the cryopreservation of these types of specimens, the first of which is referred to as conventional cryopreservation, and the second of which is referred to as vitrification.

The conventional cryopreservabon method refers to the forming of ice crystals during the freezing process and the removal of such during the thawing process.

The conventional vitrification method refers to the solidification of the specimens in a solution of reduced and lowered temperature, not by ice crystallization formation, but by extreme elevation of sample viscosity during cooling. Then the specimens are “warmed” as opposed to “thawed”. The amounts of specific materials, such as cryopreservatives and culture medium may vary between the methods.

We will refer herein to these two different methods as being interchangeable, although they may vary in the steps, number of steps, materials and terminologies used when performing different procedures or protocols. Therefore, for the purpose of describing procedures, steps or protocols herein, we will refer to “freezing” or “cryopreservation” when cold is applied to the specimen in both procedures, and “thawing” when the specimen is subjected to warming or being taken out of a frozen state.

The problems posed by the current methodology is that technicians are relying on common Petri dishes in these type of processes for the preparation of human and animal specimens for cryopreservation and thawing. These dishes are not well suited for these processes since they may not contain a desired number of wells, are not configured to facilitate these types of processes, and do not allow the technician to readily follow a fixed set of protocols or procedures each time.

Currently, common Petri dishes used to freeze and thaw the specimens may have flat bottoms, may be with or without molded integral multiple wells, and most will not contain the number of wells needed to complete the desired tasks. For those dishes without wells, the technician may simply create a droplet or micro-droplet of the solution to be used and then put the specimen into those drops. When the dishes have wells, they may have a single well or up to four wells.

Additional problems faced by the use of these common Petri dishes is that the procedures in question utilize several different media solutions and the technician must use dishes that may not adapt well to the task, or the technician may try to adapt his or her procedures, steps or protocols, and the timing of the steps, to comply with the restrictions imposed by the dish used. The result is an ineffective performance of the procedures to be followed and thus poor results. The reduced number of wells may also force the individual technicians to use more than one dish adding to the confusion, creating possible errors, and complicating the performance of the procedures.

In these procedures, the use of multiple vials and different types of medium solutions within these vials, which may contain different compositions of ingredients or greater or lesser amounts of one particular ingredient will occur. An example of this is where Vial #1 is a washing solution, and is used in the beginning of preparation of human oocytes. The washing solution is a base media and does not contain any cryopreservatives. A Vial #2 contains this same base media along with 1,2-propanediol (PrOH) as a cryopreservative; and a Vial #3 contains the same base media along with 1,2-propanediol (PrOH), as a cryopreservative and a small amount of sucrose. It is important to use these vials in their correct sequence, and for a predetermined period of time, in order to properly prepare the oocytes for cryopreservation.

An additional problem inherent in the current systems, is that once the technician has dispensed the various media into the dish from vials #1, #2 and #3, and therefore from their original containers, it is very difficult to visually differentiate these liquid meda one from another. This may result in the technician becoming confused, or result in the liquid solutions to become mixed up, resulting in them being used in an incorrect sequence and/or for incorrect lengths of time. This may have a detrimental impact on achieving the desired results and may, in fact, put the specimens at risk.

The above problems can become compounded by the fact that several of the procedures and protocols utilize the dispensing of one of the media solutions from the same vial into two separate droplets or wells. This makes monitoring the different liquids medium more difficult, and it is also more difficult to maintain the correct sequence of uses.

Another problem imposed by the use to generic dishes is that the procedures, steps or protocols used for the freezing of the specimens are very concise and need to be followed very closely. Along with the fact that these procedures need to be followed very closely, the medium solutions need to be used in a specific sequence and need to be timed very closely, as to the time each specimen remains in the different solutions and need to be moved.

Another problem arising from the use of current Petri dishes, methods and materials is that the success of the freezing of the specimens and the thawing of the specimens greatly impact the success of the overall procedure. This can impact the recovery rate and the ability for the frozen specimens to be useful after thawing. In other words, the current methods and the difficulty of applying the methods in an orderly and timely fashion will directly impact the survival of a specimen such as a human embryo which must then fertilize, mature, grow, be implanted and eventually become a live birth as a human.

Another significant problem with the use of generic Petri dishes is that individuals develop different variations of media products mixes. One individual may use three freezing solutions, while another individual may use four freezing solutions. This creates a confusion of the materials to be used as well as an inconsistency in the sequences used when using the various products

Currently the cryopreservation techniques for embryo freezing and thawing may result in a post-thaw survival rate of between 10% and 40% for the same individual technicians. Some of the results from freezing and thawing of human oocytes may vary from 0 (zero) recovery to 70% recovery. These problems are caused by the inconsistencies in application and timing in the current techniques.

Current dishes used do not display relative instructions as to the layout of the dish and the most effective method for using the dish for the procedure to be implemented. Most of the generic dishes used are adapted by the individual technicians and may be used differently each time by the same individual. In other words current dishes and the instructions do not provide a “road map” for their usage nor instructions for the correct or most effective use of the dish or apparatus. These dishes do not adept easily to different procedures or protocols that are used by different individuals according to their own preferences and likes. As a result, different technicians find different application methods. For procedures such as oocyte freezing or vitrification this will result in differing use, differing outcome and may result in drastic variations in results.

Most of the laboratory dishes in use today contain a fitted cover or lid to cover them for the shipping and during use. These lids are usually transparent and used to cover the specimens in the dish to protect them from outside contaminants or to help keep the contents from evaporating. These lids do not indicate the use of the dish, give instructions or mimic the dish in its layout. Therefore, the current lids used in these types of applications do not have any coordination with the use of the dish or its layout.

It would be highly desirable to have an apparatus, which can be used for the preparation of cells or tissues for cryopreservation and thawing, or for the preparation of cells or tissues for the process of vitrification which would be universal in its use and be adaptable to many procedures and protocols.

It would be highly desirable to have an apparatus, which can be used for the preparation of cells or tissues for cryopreservation and thawing, or for the preparation of cells or tissues for the process of vitrification which would clearly maintain indexing of the various materials used, thereby facilitating their correct use and reducing the possibility of accidentally interchanging these materials, resulting in their incorrect use and poor results.

It would be highly desirable to have an apparatus, which can be used for the preparation of cells or tissues for cryopreservation and thawing, or for the preparation of cells or tissues for the process of vitrification, that will be adaptable to different sets of instructions for its use.

### DISCLOSURE OF THE INVENTION

This invention relates to a specimen dish for use in the preparation of specimens for cryopreservation or vitrification, and/or for thawing or cooling frozen or vitrified specimens. The dish is used in the cryopreservation and thawing of specimens which can include mammalian embryos, oocytes, immature oocytes, ovarian tissue, and may be used for additional specimens of cells, tissues or stem cells. The dish may be made of a polymer, preferably polystyrene or other material suitable for use with cells and tissues, and may be post molding treated with the chemical Corona to prepare its surface for such uses. The material must be embryo-safe and non-toxic, and must be durable enough so as not to scratch easily and so as to maintain its shape. The material should be clear so that its contents may be monitored with a microscope with little or no distortion.

The specimen dish of this invention is particularly adapted for the cryopreservation of human oocytes. Human oocytes are large single cells and are therefore difficult to freeze and thaw so that they may thereafter be fertilized and eventually result in a live birth. This is due in part to the difficult nature of freezing oocytes in general, but also to the lack of consistency and treatment of the oocytes when being prepared for cryopreservation and thawing. The dish of this invention will provide consistency of oocyte treatment and will also allow the technicians to be more consistant regarding the liquid medium utilized, and the timing of each step during the procedure by utilizing the control features implanted in the dish of this invention.

The dish preferably contains a series of wells, each of which may be indexed with a number, letter or symbol to indicate the sequence of use or the use per se of each well. The indexing allows the technician to follow instructions which facilitate proper use of the container. One of the features of the dish of this invention relates to the sequencing of the wells and the configuration of the dish which enables the technician to readily utilize the dish for the washing, treating and the overall cryo-preservation preparation. One method of sequencing is a progression from left to right of individual wells, with multiple rows of wells going from top to bottom. This enables the technician to maintain separation of the specimens. An additional feature is the fact that the last row to the right is separated from the remaining wells or rows of wells, by a vertical wall. The purpose of this wall is to allow the technician to submerge the specimens under paraffin oil during the process through the first several wells and then to allow them to hold the specimen in the last well, without being under oil. The purpose of the oil is to allow the technician to work in an open environment protecting the specimen from the environment, evaporation and a pH shift by having the specimens under oil. This will allow the technician to extract the specimen from the apparatus without including oil into the pipette or into the freezing straw. This allows the freezing straw to be oil free, and then as a result the paraffin oil material would not then impact the freezing process.

The dish may include a cover lid which will have the same layout, visual indicators and configuration of the wells and indexes that are incorporated in the dish. When the cover lid is on top of the dish the wells and indexes will align with each other. This will allow the technician to readily understand and apply the instructions that are designated for the use of the apparatus. This will also allow the technician to indicate on the lid with a marker, a pen, or an etching device to indicate into which well each of the solutions are to be aliquoted. This will then allow the technician to lay the lid along side of the apparatus and allow the technician to keep track of the solutions aliquoted into each well.

Another feature of this lid, is that it can have an indicator, which will be keyed with the apparatus to insure that it lid aligns with the apparatus each time. One example of a “key” is a triangular cutout in both the dish and the lid. This lid feature will also allow instructions to be written for various and different procedures, clearly indicating the different wells, indexing and the sequence for their use. The instructions will allow the dish to be readily adapted to multiple procedures and applications. The indicators, diagrams or instructions displayed on the lid may be etched or molded on the top surface or may be in or on the underside of the lid as to allow the technician to write, etch, or otherwise mark information on the lid. The set of instructions will also allow the technician to maintain a sequence of events by allowing the technician to indicate on the instructions the timing of events during the process. The maintenance of these timed events may include such indicators as the time the process was begun, the time period the specimens are to remain in the solutions and the time the specimens are to be removed form the solutions. These instructions may be presented in detail, whereby the instructions are listed and the technician simply insets the start time, and then progresses through the instructions and adds the times listed on the instructions to the beginning and/or to the prior time or event listed, which will then update the time in the instructions that would be pertinent to the event occurring at that time.

The following examples illustrate uses of the dish of this invention:

### EXAMPLE ONE

This example relates to the freezing of oocytes. This procedure uses a plurality of media which are of two or more different media types. These different types of media solutions may be pre-made and are stored in separate vials, Vial 1, Vial 2 and Vial 3. The amounts of the solutions may also be of different quantities. In this example Vial 1 contains twenty ml of a medium, Vial 2 contains ten ml of a medium, and Vial 3 contains ten ml of a medium. The vials may contain different compositions of ingredients, or a greater amount of one particular ingredient. In this example Vial 1 contains a basic media solution used as a washing solution for the beginning of the oocytes preparation; Vial 2 contains a base media solution and 1,2-propanediol (PrOH) as a cryopreservative; and Vial 3 contains a basic media solution, 1,2-propanediol (PrOH) and sucrose for further preparing the oocytes for cryopreservation. Additionally, in this example, a set of procedural insturctions may be applied to Vials 1, 2 and 3.

In the preparation of oocytes for freezing process, the freezing process utilizes three separate vials or solutions. Vial 1 contains twenty ml of basic medium composition with 10% human serum albumin (HSA) and 0.2M sucrose (Solution 1); Vial 2 contains ten ml of a base medium and 10% HSA (Solution 2); and Vial 3 contains five ml of 1,2 propanediol (Solution 3).

Typical steps to be followed are as follows: 1) remove the preparation dish of the invention from its bag or pouch and allow the dish to equilibrate to room temperature; 2) assemble all of the freezing solutions which are in Vials 1, 2 and 3 in the workspace and perform the following procedure in an aseptic environment, using aseptic procedures; 3) warm Vials 1, 2 and 3 to room temperature prior to use; 4) put 3 ml of Solution 1 of into well 1-A, put 0.5 ml of Solution 2 into well 2-A, and put 0.5 ml of Solution 3 into dry well 6-A (this well is not under oil); 5) transfer oocytes into well 1-A containing Solution 1 and wash for two minutes; 6) after washing with Solution 1, transfer oocytes to Solution 2 in well 2-A; 7) leave oocytes in Solution 2 for ten minutes at room temperature; 8) transfer oocytes into Solution 3 into well 6-A and leave in Solution 3 for three minutes.

Prior to the start of the cooling procedure, the total oocyte specimen preparation time is fifteen minutes at room temperature. After the preparation is completed, the oocyte specimens will be loaded into freezing straws and then cooled down and then frozen in liquid nitrogen and stored there until thawing.

Thawing:

After the specimens have been frozen for the desired length of time they will be removed from the freezing tank or freezer. When the specimens are to be recovered or used, the straws to be thawed are taken from the nitrogen chamber and the specimens are then thawed using the procedure described below. The procedure to be used can be printed in a set of instructions which are attached to the specimen treating dish. Alternatively, the procedural instruction section of the dish can be left blank so that the technician can write down whatever specific set of thawing steps he or she desires to be performed on that section of the dish.

Thawing solutions to be used are: twenty ml of base media, 10% HSA and 0.2M sucrose (Solution 4) which is contained in Vial 4; ten ml of base media 10% HSA & 0.1 M sucrose (Solution 5) which is contained in Vial 5; ten ml of base media and 10% HSA (Solution 6) which is contained in Vial 6; and five ml of 1,2 propanediol (Solution 7) which is contained in Vial 7.

The specimen thawing procedure includes the following steps: 1) remove the preparation container or dish from the bag or pouch and allow the dish to equilibrate to room temperature; 2) assemble all thawing solutions in the workspace and perform the work in an aseptic environment using aseptic procedures; 3) warm Vials 4, 5, 6 and 7 to room temperature prior to use; 4) put 0.5 ml of Solution 4 into well 1-A; 5) put 0.5 ml of Solution 5 into well 2-A; 6) put 0.5 ml of Solution 6 into well 3-A; 7) put 0.5 ml of Solution 7 into well 4-A; 8) air warm straw(s) for thirty seconds; 9) immerse straws in a 30° C. water bath until all traces of ice have disappeared, approximately forty seconds; 10) transfer oocytes from straws to well 1-A for 5 min at room temperature; 11) transfer oocytes to well 2-A for 5 min at room temperature; 12) transfer oocytes to well 3-A for 10 min at room temperature; 13) transfer oocytes to well 4-A for 10 min at room temperature and for an additional 10 minutes at 37° C.; and 14) transfer oocytes to culture medium at 37° C. for further handling and fertilization. This ends the thawing process and then the specimens can be used for whatever procedure they have been thawed for.

If so desired, the instructions section of the dish can have a time line chart printed on it which may be of the type set forth below. The technician can use this chart to record the times of each of steps 9-15 and the time of day which each step was begun and completed.

| | | |
|---|---|---|
| Dwell Time | Start Time of Day | (TOD) |

| | | |
|---|---|---|
| Step 9 | 30 seconds | TOD |
| Step 10 | 40 seconds | TOD |
| Step 11 | 5 minutes | TOD |
| Step 12 | 5 minutes | TOD |
| Step 13 | 10 minutes | TOD |
| Step 14 | 10 minutes | TOD |
| Step 15 | | TOD |

It is therefore an object of this invention to provide a specimen sampling dish which is adapted for improved preparation for cryopreservation and thawing of oocytes and/or other cell types and biological specimens so as to improve their chances of recovery and in the case of oocytes, the eventuality of them resulting in a live birth.

It is a further object of this invention to increase the utility of the dish with a multiplicity of different and various instructions which can be printed on the dish.

It is an additional object of this invention to combine the dish with a cover lid which will allow the recording of certain pertinent information on the lid to allow the technician to document the solutions used in the various wells or specimen receptor spaces in the dish.

It is yet another object of this invention to provide a dish of the character described that will increase the consistency of methods for an application which may be difficult due to the inherent difficulties associated with the application of the process, such as the freezing and thawing of human oocytes.

These and other objects and advantages of this invention will become more readily apparent from the following detailed description of a specific embodiment of the invention when taken in conjunction with the accompanying drawings, in which:

### BRIEF DESCRIPTION OF THE DRAWINGS

FIG. 1 is a perspective view of a specimen processing dish which is formed in accordance with this invention;

FIG. 2 is a plan view of the dish of FIG. 1 which highlights features of the dish;

FIG. 3 is a side sectional view of the dish of FIG. 1; and

FIG. 4 is an exploded perspective view of the dish and a lid which is designed for use with the dish.

### DETAILED DESCRIPTION OF SPECIFIC EMBODIMENTS OF THE INVENTION

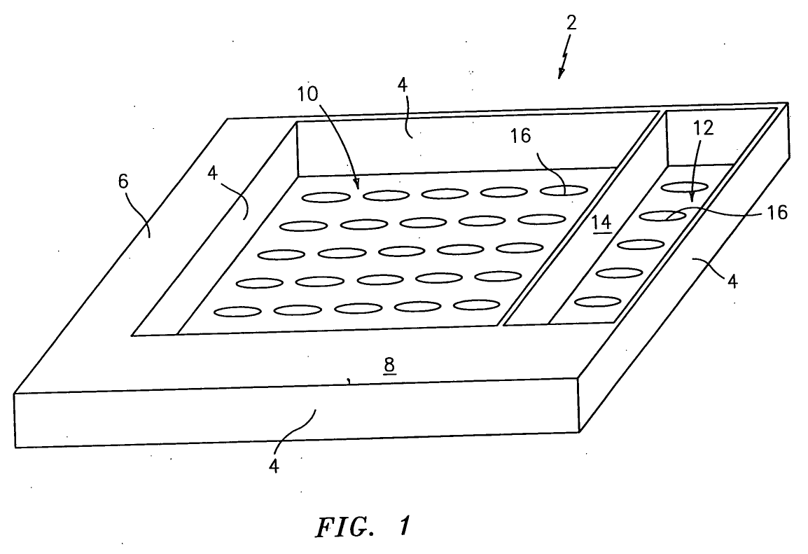

FIG. 1 is a perspective view of an apparatus formed in accordance with this invention which takes the form of a specimen processing dish 2. The dish 2 may be used for the cryoprservation and/or vitrification of tissues, embryos or oocytes. The outer walls 4 are used to contain any fluids used in the apparatus. The dish 2 has information surfaces 6 and 8 on which information, such as procedural instructions, procedural steps, specimen identification, technician identification, patient identification, just to name a few, can be displayed. This information can be preprinted on the surfaces 6 and 8, or can be entered thereon by a technician using the dish 2 for specimen treatment. The dish 2 is divided into two chambers 10 and 12 by an internal wall 14 which extends from one of the outer walls 4 to an opposite outer wall. Each of the chambers 10 and 12 is provided with reagent and specimen-receiving wells 16 which are arranged in columns of rows. As noted in FIG. 1, there may be five columns of wells 16 each of which has five individual wells 16 therein in chamber 10, with chamber 12 having one column of the wells 16 therein. The purpose of the wells 16 will be set forth in greater detail hereinafter.

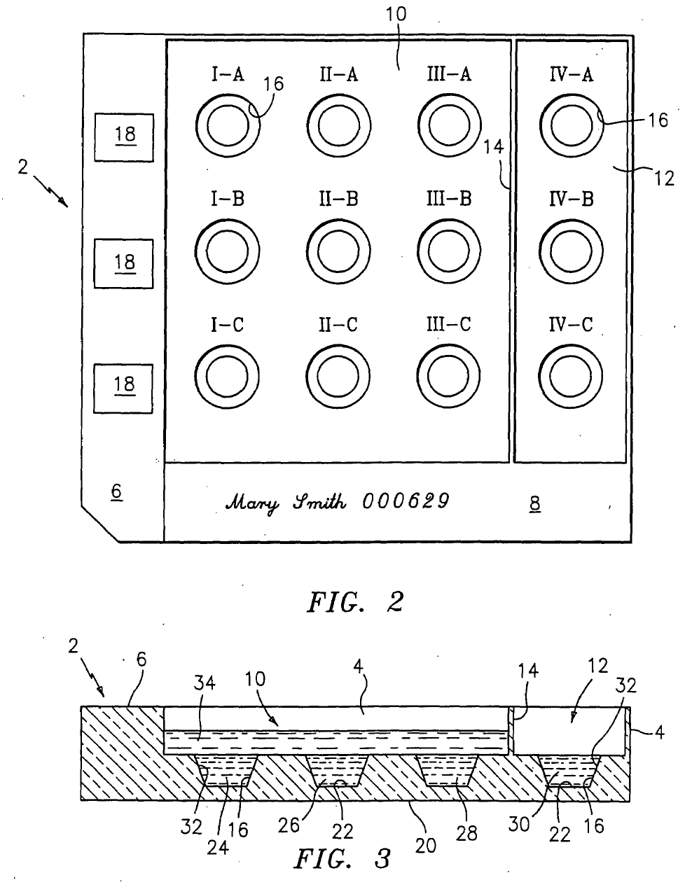

FIG. 2 is a plan view of an embodiment of the dish 2 which includes a total of twelve of the wells 16 arranged in four columns of four wells each. The interior wall 14 partitions the dish 2 so that nine of the wells 16 are in the compartment 10 and three of the wells 16 are in the compartment 12. The dish 2 shown in FIG. 2 is designed for a specimen treatment procedure that includes three sequential steps. For identification purposes, the wells 16 in compartment 10 are visibly labeled I-A, II-A, III-A, I-B, II-B, III-B, and so on. Thus, the uppermost row of wells 16 in compartment 10 can be deemed to be the A wells, then there are the B wells and the C wells in compartment 10. The dish 2 shown in FIG. 2 is also designed to treat three samples of the same specimen. One exemplary use of the dish 2 shown in FIG. 2 is to use it to prepare oocytes for cryopreservation. Three separate oocytes can be thusly prepared, one in each of the rows of wells 16. Thus, the oocytes could be considered to be oocyte A, oocyte B and oocyte C. They would all be from the same donor. The preparation steps could be considered to be Step I, Step II and Step III. The wells 16 in the compartment 12 are for the reception of the prepared oocytes after the performance of Step III. It will be noted that the oocyte donor's identity can be displayed on panel 8 along with her identification number. Thus, the oocytes which are treated in the dish 2 will have an identification number and a donor identification with them for the subsequent cryopreservation procedure. The panel 6 can have three different labels 18 which can be used to display the preparation steps I, II and III to be performed, or they can be used by the technician to write down the times the individual steps were started and completed, or any other information. Thus the labels 18 can be used for information relating to the steps that the oocytes undergo during the preparation procedure.

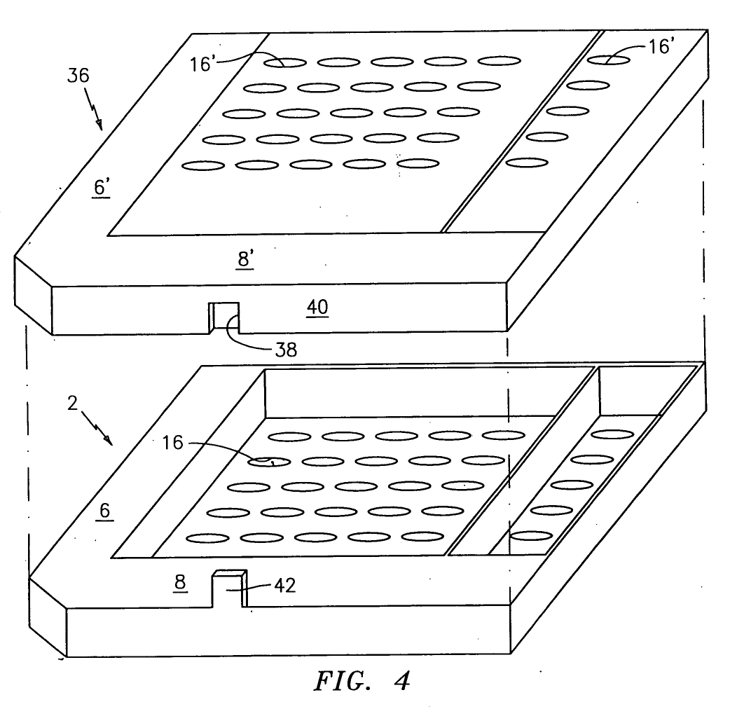

FIG. 3 is a side sectional view of the dish 2. The dish 2 has the raised outer walls 4, a flat writable surface 6, the wells 16, and a separation wall 14, which separates the nine wells 16 I-Ill in the compartment 10 from the three wells 16 IV in the compartment 12. The dish 2 has a flat bottom wall 20 and each of the wells 16 has a flat bottom wall 22. The bottom walls 20 and 22 are closely spaced apart from each other so that the prescribed different media solutions 24, 26, 28 and 30 disposed in the wells 16, and the specimens therein, can be appropriately heated by a heated work surface on which the dish 2 will be positioned during the preparation steps which are performed in the wells 16. The wells 16 have tapered side walls 32 which ensure that the oocytes or other specimens being treated in the wells 16 will descend to the bottom 22 of the wells 16 during the treatment or preparation steps being performed on them. The tapered side walls 32 also enable visualization of the specimens during preparation and treatment of them in the wells 16, and allow ease of access with pipettes or microtools for pickup and transfer of the specimens into and between the wells 16 of the dish 2.

In an oocyte cryopreservation preparation procedure wells 16 will be filed with cryopreservation preparation media, and then overlaid with paraffin oil 34. This paraffin oil 34 helps to maintain the pH level of the media and keeps the media from evaporating. The specimens are then moved through the wells 16, each of which contains a different cryopreservation media. The separation wall 14 keeps the oil from flowing into the wells 16 that are in the compartment 12. Wells IV-A, IV-B and IV-C are not overlaid with the oil 34 so as to allow the technician to wash the specimens in the final media solution and at the same time wash off the specimens any paraffin oil residue that may exist. The specimens will then be moved from wells IV-A, IV-B and IV-C to a cryopreservation device such as a freezing straw.

FIG. 4 is an exploded perspective view of the dish 2 shown in combination with a lid or cover 36 which can be used to cover the dish 2 both prior to and during use. The cover 36 is formed from a transparent material so that the contents of the wells 16 in the dish can be observed through the cover 36. The cover 36 has a cutout notch 38 in one side wall 40 which receives a matching projection 42 on the dish 2. The notch 38 and projection 42 assure proper alignment of the cover 36 and the dish 2 when the cover is used to close the dish. The cover 36 has marginal sections 6′ and 8′ which overlie the sections 6 and 8 on the dish 2. These overlying sections can be used for the entry of information regarding the contents of the dish 2, or can simply cover the information-containing sections 6 and 8 on the dish 2. The cover 36 contains a plurality of areas 16′ which correspond to the wells 16 in the dish 2 and directly overlie the wells 16. These areas 16′ can be embossed into the cover 36 or can be printed or etched onto the cover 36 so as to render them visually distinct. The areas 16′ can be used to display information regarding the contents of the dish 2 such as time tables of each of the treatment steps that have been performed on the specimens in the wells 16, or any other pertinent information relating specifically to each of the wells 16 which underlies the corresponding areas 16′.

It will be readily appreciated that the dish assembly of this invention will improve and better organize steps and reagents used in the preparation of cells and tissue for cryopreservation and/or vitrification. The dish assembly of this invention will also improve and better organize thawing steps which are used to thaw frozen specimens which will result in a likelihood of a greater chance of the specimens recovering and becoming useful specimens able to fulfill subsequent growth and maturity goals. The dish assembly of this invention will also enable better recovery of difficult specimens to cryopreserve and resurrect such as human oocytes and embryos.

Since many changes and variations of the disclosed embodiment of the invention may be made without departing from the inventive concept, it is not intended to limit the invention except as required by the appended claims.

What is claimed is:

1. A container for use in the preparation of mammalian specimens for cryopreservation and/or vitrification, and for thawing and using such specimens, said container comprising:
a) a first compartment containing a plurality of specimen-receiving wells, said wells being arranged in a grid pattern comprising columns and rows of aligned wells;
b) side walls surrounding said first compartment so as to isolate said grid of wells from ambient surroundings; and
c) at least two shelves disposed adjacent to two adjacent ones of said side walls, said shelves providing surfaces upon which information regarding the specimens in each of said rows and columns of wells can be displayed.

2. The container of claim 1 further comprising a second compartment separated from said first compartment by a wall, said second compartment containing a column of wells in which individual wells in said column are aligned with corresponding wells in the columns thereof in said first compartment.

3. The container of claim 2 wherein one of said shelves is also disposed adjacent to said second compartment.

4. The container of claim 3 further comprising specimen specific information displayed on said shelves in areas of said shelves which are aligned with individual rows and columns of said wells.

5. The container of claim 4 wherein said wells are formed as depressions in a bottom wall of said container.

6. The container of claim 5 further comprising indicia disposed on said bottom wall adjacent to each well, said indicia identifying the location of the column and row of each of said wells in said grid.

7. A container assembly for use in the preparation of mammalian specimens for cryopreservation and/or vitrification, and for thawing and using such specimens, said container comprising:
a) a first compartment containing a plurality of specimen-receiving wells, said wells being arranged in a grid pattern comprising columns and rows of aligned wells;
b) side walls surrounding said first compartment so as to isolate said grid of wells from ambient surroundings; and
c) at least two shelves disposed adjacent to two adjacent ones of said side walls, said shelves providing surfaces upon which information regarding the specimens in each of said rows and columns of wells can be displayed.

8. The container assembly of claim 7 further comprising a second compartment separated from said first compartment by a wall, said second compartment containing a column of wells in which individual wells in said column are aligned with corresponding wells in the columns thereof in said first compartment.

9. The container assembly of claim 8 further comprising a cover member for overlying said first and second compartments, said cover member including visually distinct areas which overlie each of the wells in said first and second compartments, said visually distinct areas providing means for displaying information about the contents of each of the respective underlying wells in said first and second compartments.

10. The container assembly of claim 9 wherein said cover member includes means for keying its position relative to said first and second compartments to ensure that each of said visually distinct areas is aligned and overlies corresponding ones of said wells.
